(19) United States
(12) Patent Application Publication
(10) Pub. No.: US 2015/0074167 A1
(43) Pub. Date: Mar. 12, 2015

(54) INFORMATION PROCESSING DEVICE, INFORMATION PROCESSING METHOD, SERVER DEVICE, RETRIEVAL METHOD, AND INFORMATION PROCESSING SYSTEM

(71) Applicant: Sony Corporation, Minato-ku, Tokyo (JP)

(72) Inventors: Shuhei Sonoda, Kanagawa (JP); Masayuki Takada, Tokyo (JP); Goragot Wongpaisarnsin, Tokyo (JP)

(73) Assignee: Sony Corporation, Minato-ku, Tokyo (JP)

(21) Appl. No.: 14/386,475

(22) PCT Filed: Feb. 27, 2013
(86) PCT No.: PCT/JP2013/055227

§ 371 Date: Sep. 19, 2014

(30) Foreign Application Priority Data
Mar. 29, 2012 (JP) 2012-075307

(51) Int. Cl. H04L 29/08; G06F 9/54

(52) U.S. Cl. CPC H04L 67/10; G06F 9/54
USPC 709/201

(57) ABSTRACT

There is provided an information processing device including an information acquiring unit that acquires an operating environment of an application and function information indicating a function required by the application, and a program acquiring unit that acquires a program corresponding to the operating environment and the function information.

### TECHNICAL FIELD

The present disclosure relates to an information processing device, an information processing method, a server device, a retrieval method, and an information processing system.

### BACKGROUND ART

Recently, as mobile devices such as a smartphone have become widespread, it is becoming common that users freely install applications on mobile devices as well as personal computers (PCs). Therefore, applications are installed on various devices to provide users with various services. When services are provided by applications, various functions are required by the applications, but such functions can be realized by executing programs. The executed programs can be obtained from, for example, a server device (see, for example, Patent Literature 1).

Here, operating environments of applications are also various. Thus, for example, even though there is a plurality of situations in which the same function is required by the same application, the operating environments of the applications are not necessarily equal to one another in each situation. Therefore, various techniques have been developed to provide appropriate functions to applications by execution of programs even when the operating environments of the applications are different from one another.

For example, there is a technique that redundantly prepares programs corresponding to functions required by applications in advance. According to such technique, even in a plurality of situations in which operating environments of the applications are different from one another, appropriate functions can be provided to the applications by acquiring and executing the redundantly provided programs.

Also, for example, there is a technique that prepares different applications for each operating environment of the applications. According to such technique, since different programs are executed for each application, appropriate functions can be provided to the applications by acquiring and executing programs corresponding to the applications.

### CITATION LIST

### Patent Literature

Patent Literature 1: JP 2009-116668 A

### SUMMARY OF INVENTION

### Technical Problem

However, the technique that redundantly prepares programs corresponding to functions required by applications in advance takes much time and effort to prepare redundant programs. Also, the technique that prepares different applications for each operating environment of the applications takes much time and effort to prepare different applications for each operating environment.

Therefore, it is desirable to provide a technique that can easily acquire programs for realizing functions required by applications, considering operating environments of the applications.

### Solution to Problem

According to the present disclosure, there is provided an information processing device including an information acquiring unit that acquires an operating environment of an application and function information indicating a function required by the application, and a program acquiring unit that acquires a program corresponding to the operating environment and the function information.

According to the present disclosure, there is provided an information processing method including acquiring an operating environment of an application and function information indicating a function required by the application, and acquiring a program corresponding to the operating environment and the function information.

According to the present disclosure, there is provided a server device including a program retrieving unit that retrieves a program corresponding to an operating environment of an application and function information indicating a function required by the application, and a program proving unit that provides a program acquired by retrieval of the program retrieving unit.

According to the present disclosure, there is provided a retrieval method including retrieving a program corresponding to an operating environment of an application and function information indicating a function required by the application, and providing a program acquired by retrieval.

According to the present disclosure, there is provided an information processing system including an information processing device, and a server device. The information processing device includes an information acquiring unit that acquires an operating environment of an application and function information indicating a function required by the application. The server device includes a program retrieving unit that retrieves a program corresponding to the operating environment and the function information, and a program proving unit that provides a program acquired by retrieval performed by the program retrieving unit to the information processing device.

### Advantageous Effects of Invention

As described above, according to the present disclosure, it is possible to provide a technique that can easily acquire programs for realizing functions required by applications, considering operating environments of the applications.

### BRIEF DESCRIPTION OF DRAWINGS

FIG. 1 is a diagram illustrating a configuration example of an information processing system according to an embodiment of the present disclosure.

FIG. 2 is a diagram illustrating an overview of an information processing system according to an embodiment of the present disclosure.

FIG. 3 is a diagram illustrating a functional configuration example of an information processing device according to an embodiment of the present disclosure.

FIG. 4 is a diagram illustrating a functional configuration example of a server device according to an embodiment of the present disclosure.

FIG. 5 is a diagram illustrating an example of a program retrieval function.

FIG. 6 is a diagram illustrating an example of a program retrieval function.

FIG. 7 is a diagram illustrating an example of a program retrieval function.

FIG. 8 is a diagram illustrating an example of a program retrieval function.

FIG. 9 is a diagram illustrating an example of a program retrieval function.

FIG. 10 is a diagram illustrating an example of a program retrieval function.

FIG. 11 is a diagram illustrating an example of an operation history update function.

FIG. 12 is a diagram illustrating an example of a meta information update function.

FIG. 13 is a flowchart illustrating a flow of an operation of an information processing system according to an embodiment of the present disclosure.

### DESCRIPTION OF EMBODIMENT

Hereinafter, preferred embodiments of the present disclosure will be described in detail with reference to the appended drawings. Note that, in this specification and the drawings, elements that have substantially the same function and structure are denoted with the same reference signs, and repeated explanation is omitted.

The preferred embodiments of the present invention have been described above with reference to the accompanying drawings, whilst the present invention is not limited to the above examples, of course. A person skilled in the art may find various alterations and modifications within the scope of the appended claims, and it should be understood that they will naturally come under the technical scope of the present invention.

Also, the “mode for carrying out the invention” will be described in the following order.
1. Embodiments
1-1. Configuration Example of Information Processing System
1-2. Overview of Information Processing System
1-3. Functional Configuration Example of Information Processing Device
1-4. Functional Configuration Example of Server Device
1-5. Program Retrieval Function
1-6. Operation History Update Function
1-7. Meta Information Update Function
1-8. Operation Example of Information Processing System
2. Conclusion

### 1. Embodiments

First, embodiments of the present disclosure will be sequentially described in detail.

<1-1. Configuration Example of Information Processing System>

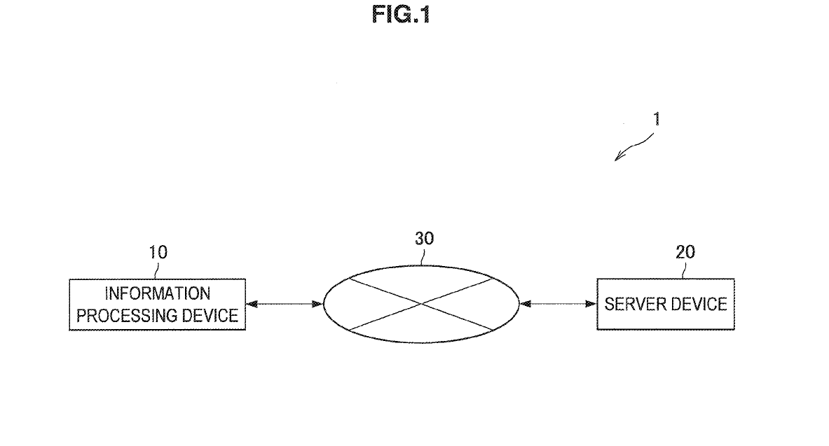

First, a configuration example of an information processing system 1 according to an embodiment of the present disclosure will be described. FIG. 1 is a diagram illustrating a configuration example of the information processing system 1 according to the embodiment of the present disclosure.

As illustrated in FIG. 1, the information processing system 1 according to the embodiment of the present disclosure includes, for example, an information processing device 10 and a server device 20. The information processing device 10 and the server device 20 are connected to a network 30 and can communicate with each other through the network 30. However, the configuration illustrated in FIG. 1 is merely exemplary. For example, in FIG. 1, one information processing device 10 is connected to the network 30, but a plurality of information processing devices 10 may be connected to the network 30. Also, the network 30 may be Internet, wireless LAN, 3G network, or other networks.

When an application is run, the information processing device 10 acquires programs for realizing functions required by the application from the server device 20 through the network 30. The information processing device 10 may be, for example, any type of devices such as a smartphone, a personal computer (PC), a tablet computer, and the like. A kind of the application run by the information processing device 10 or the programs for realizing the functions required by the application is not particularly limited.

The server device 20 retrieves programs for realizing the functions required by the application run in the information processing device 10. Also, the server device 20 provides the programs obtained by such retrieval to the information processing device 10 through the network 30. The server device 20 may be, for example, any type of devices such as a PC or the like. Also, as illustrated in FIG. 1, the server device 20 may be constituted separately from the information processing device 10, or may be integrally formed with the information processing device 10.

Also, the server device 20 may be generally realized by a computer that is managed by an operator. However, in the present specification, the server device 20 is not limited to this example and may be realized by any devices. For example, in the present specification, the server device 20 may be realized by a device such as a home server or the like.

Here, as described above, operating environments of applications are various. Thus, for example, even though there is a plurality of situations in which the same function is required by the same application, the operating environments of the applications are not necessarily equal to each other in each situation. Therefore, it is desirable to provide appropriate functions to applications by execution of programs even when the operating environments of the applications are different from one another.

However, the technique that redundantly configure programs corresponding to functions required by applications in advance, or the technique that prepare different applications for each operating environment of the applications takes much time and effort to prepare the programs or the applications. Therefore, the embodiment of the present disclosure proposes a technique that can easily acquire programs for realizing functions required by applications, considering operating environments of the applications.

So far, the configuration example of the information processing system 1 according to the embodiment of the present disclosure has been described. Subsequently, the overview of the information processing system 1 according to the embodiment of the present disclosure will be described.

<1-2. Overview of Information Processing System>

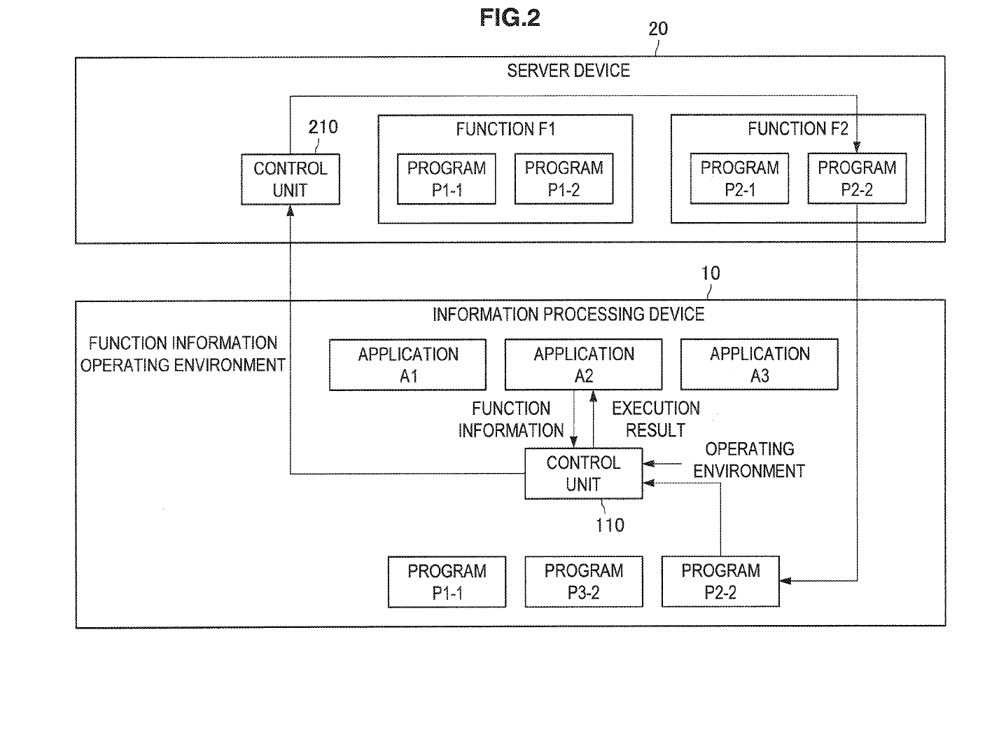

FIG. 2 is a diagram illustrating the overview of the information processing system 1 according to the embodiment of the present disclosure. As illustrated in FIG. 2, the information processing device 10 can run the application. In FIG. 2, as the application that can be run by the information processing device 10, an application A1, an application A2, and an application A3 are illustrated, but the number of applications that can be run by the information processing device 10 is not particularly limited. For example, the application is run according to the control of the control unit 110. Here, a case where the application A2 is run according to the control of the control unit 110 will be described as an example.

In a state in which the application A2 is run, a function is required by the application A2. A kind of the function is not particularly limited. For example, the function required by the application A2 may be a face analysis function of analyzing a face projected on an image, which will be described below. For example, the control unit 110 acquires function information indicating the required function from the application A2. On the other hand, the control unit 110 acquires the operating environment of the application A2.

The operating environment of the application A2 may be acquired from, for example, an operating system (OS) run by the information processing device 10, but an entity that provides the operating environment is not particularly limited. The operating environment of the application A2, for example, may include information indicating the capability of the information processing device 10 to operate the application A, and may include information indicating the state of the information processing device 10 to operate the application A2.

The capability of the information processing device 10 corresponds to static information among pieces of information on the information processing device 10. The capability of the information processing device 10 is not particularly limited. For example, the capability of the information processing device 10 may be the performance of a central processing unit (CPU) for operating the information processing device 10, or may be the performance of a memory for operating the information processing device 10.

Also, the capability of the information processing device 10 may be a capacity of a storage used for the operation of the information processing device 10, or may be a maximum communication rate of the information processing device 10. Also, the capability of the information processing device 10 may be a capacity of a battery used by the information processing device 10, or may be a program language that is operable in the information processing device 10. Also, the capability of the information processing device 10 may be information on the presence or absence of predetermined hardware that can be used by the information processing device 10 (for example, a display, a tuner, a touch panel, a camera, and the like).

On the other hand, the state of the information processing device 10 corresponds to dynamic information among pieces of information on the information processing device 10. For example, the state of the information processing device 10 is not particularly limited, but may be a kind of an application installed on the information processing device 10, may be a version of an OS installed on the information processing device 10, or may be a support state of a program language that is compatible with the information processing device 10.

Also, the state of the information processing device 10 may be account information of an external service registered by a user, or may be a kind of an already acquired program. Also, the state of the information processing device 10 may be resource information of hardware included in the information processing device 10 (for example, a space of a CPU, a memory space, a remaining battery level, a storage space, and the like), may be a communication scheme (for example, wi-fi, 3G, and the like) used by the information processing device 10, or may be a communication rate by the information processing device 10.

Also, the state of the information processing device 10 may be power ON/OFF of hardware (for example, a display, and the like) used by the information processing device 10, or may be information on an operation of a predetermined program (for example, period, time, and location at which the corresponding program is operated). Also, the state of the information processing device 10 may be information on a running process (for example, types and the number of running processes), or may be a type of a connecting device for connection to the information processing device 10. However, it is also possible that the connecting device corresponds to static information.

Therefore, when the operating environment and the function information are acquired by the control unit 110, the control unit 110 acquires programs corresponding to the operating environment and the function information. More specifically, first, programs are prepared for each function in the server device 20. In the example illustrated in FIG. 2, a program P1-1 and a program P1-2 are prepared as programs corresponding to a function F1, and a program P2-1 and a program P2-2 are prepared as programs corresponding to a function F2. Also, the kind of the function is not particularly limited. Also, the number of programs corresponding to each function is also not particularly limited.

When the operating environment and the function information are acquired from the control unit 110 of the information processing device 10, a control unit 210 of the server device 20 selects a program corresponding to the function information. FIG. 2 illustrates an example in which the function information is assumed as indicating the function F2 and the control unit 210 selects a program P2-1 and a program P2-2 as programs corresponding to the function information. Subsequently, the control unit 210 selects a program corresponding to the operating environment. FIG. 2 illustrates an example in which the program P2-2 is selected based on the operating environment.

Such a selected program is provided by the control unit 210 of the server device 20 and is acquired by the control unit 110 of the information processing device 10. The control unit 110 realizes the function required by the application A2 by executing the acquired program and providing the execution result to the application A2. Also, in a case where the operating environment (for example, the static information, and the like) of the application A2 has already been acquired by the server device 20, the control unit 210 and the acquisition of the operating environment by the control unit 210 may be omitted because the corresponding operating environment may be used again.

Therefore, in the embodiment of the present disclosure, the program corresponding to the operating environment and the function information is acquired by the information processing device 10. Therefore, it is possible to easily acquire the program for realizing the functions required by the applications, considering the operating environments of the applications.

So far, the overview of the information processing system 1 according to the embodiment of the present disclosure has been described. Subsequently, the functional configuration example of the information processing device 10 according to the embodiment of the present disclosure will be described.

<1-3. Functional Configuration Example of Information Processing Device>

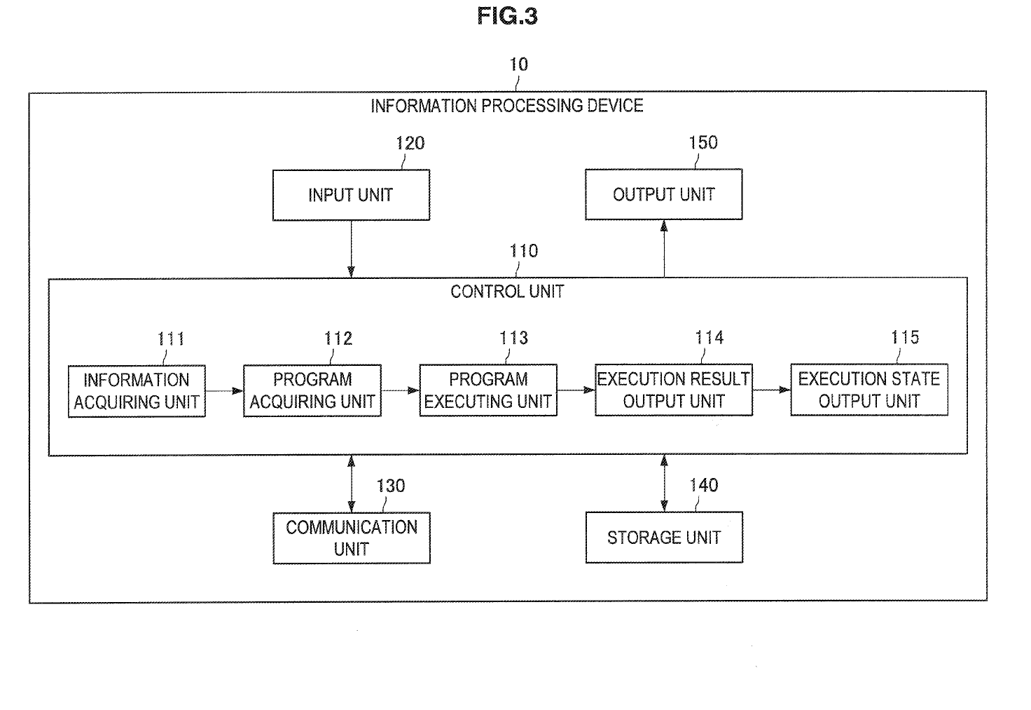

FIG. 3 is a diagram illustrating a functional configuration example of the information processing device 10 according to the embodiment of the present disclosure. As illustrated in FIG. 3, the information processing device 10 includes a control unit 110, an input unit 120, a communication unit 130, a storage unit 140, and an output unit 150. Also, the control unit 110 includes an information acquiring unit 111, a program acquiring unit 112, a program executing unit 113, an execution result output unit 114, and an execution state output unit 115.

The control unit 110 corresponds to a processor such as a CPU or a digital signal processor (DSP). The control unit 110 exhibits various functions of the control unit 110 by executing the application and the program stored in the storage unit 140 or other storage medium. The respective functions of the information acquiring unit 111, the program acquiring unit 112, the program executing unit 113, the execution result output unit 114, and the execution state output unit 115 will be described below.

The input unit 120 has a function of receiving an operation from a user. The input unit 120 outputs the operation from the user to the control unit 110 as operation information. The operation information is used by the control unit 110 and, for example, is used by the execution of the program. In the example illustrated in FIG. 2, the input unit 120 is incorporated in the information processing device 10, but the input unit 120 may be provided outside the information processing device 10.

The communication unit 130 is, for example, a communication interface that is configured by a communication device for connecting to the network 30. The communication unit 130, for example, can perform communication with the server device 20 through the network 30. The communication by the communication unit 130 through the network 30 may be performed by wireless or wire.

The storage unit 140 stores the application and the program, which are executed by the control unit 110, by using the storage medium such as a semiconductor memory or a hard disk. Also, the storage unit 140 can store data used for the execution of the application or the program. In the example illustrated in FIG. 3, the storage unit 140 is incorporated in the information processing device 10, but the storage unit 140 may be provided outside the information processing device 10.

The output unit 150 has a function of outputting information under the control of the control unit 110. For example, the output unit 150 may have a function of outputting information for allowing a user to perform the input of the operation information corresponding to the application. Also, for example, the output unit 150 may have a function of providing a service to a user by outputting the execution result of the application. The output unit 150 may be a display device that displays an image, may be an audio output device that outputs audio, and may be other output devices.

So far, the functional configuration example of the information processing device 10 according to the embodiment of the present disclosure has been described. Subsequently, the functional configuration example of the server device 20 according to the embodiment of the present disclosure will be described.

<1-4. Functional Configuration Example of Server Device>

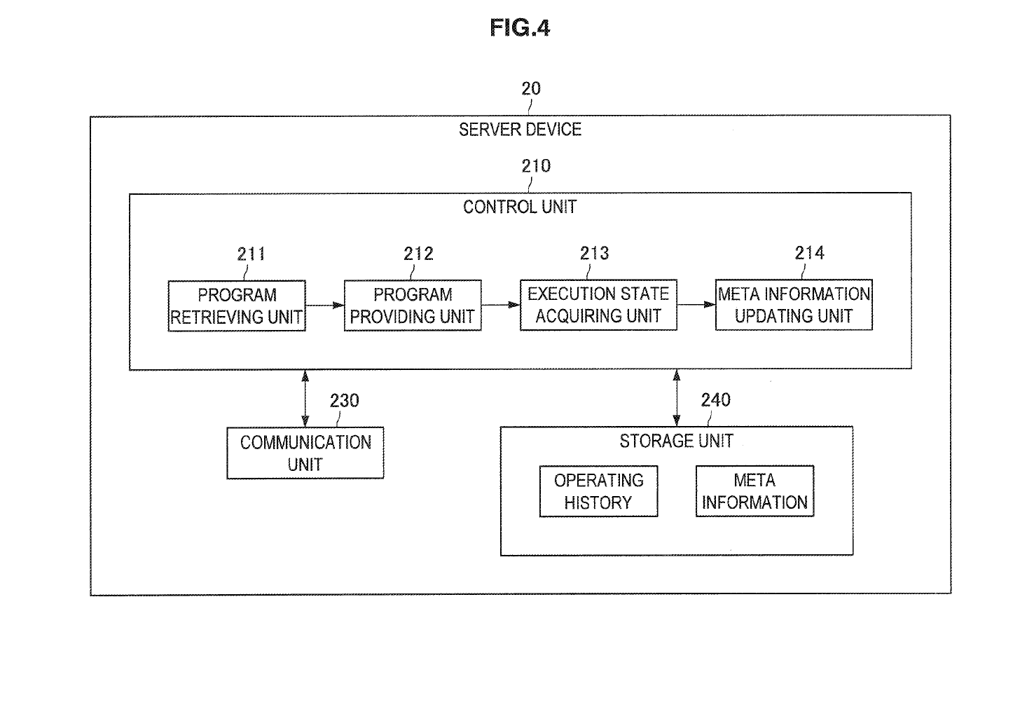

FIG. 4 is a diagram illustrating a functional configuration example of the server device 20 according to the embodiment of the present disclosure. As illustrated in FIG. 4, the server device 20 includes a control unit 210, a communication unit 230, and a storage unit 240. Also, the control unit 210 includes a program retrieving unit 211, a program providing unit 212, an execution state acquiring unit 213, and a meta information updating unit 214.

The control unit 210 corresponds to a processor such as a CPU or a DSP. The control unit 210 exhibits various functions of the control unit 210 by executing the application and the program stored in the storage unit 240 or other storage medium. The respective functions of the program retrieving unit 211, the program providing unit 212, the execution state acquiring unit 213, and the meta information updating unit 214 will be described below.

The communication unit 230 is, for example, a communication interface that is configured by a communication device for connecting to the network 30. The communication unit 230, for example, can perform communication with the information processing device 10 through the network 30. The communication by the communication unit 230 through the network 30 may be performed by wireless or wire.

The storage unit 240 stores the program executed by the control unit 210 by using the storage medium such as a semiconductor memory or a hard disk. Also, the storage unit 240 can store data used for the execution of the program. In FIG. 4, an operation history and meta information are provided as an example of data stored by the storage unit 240, but such information will be described below. In the example illustrated in FIG. 4, the storage unit 240 is incorporated in the server device 20, but the storage unit 240 may be provided outside the server device 20.

So far, the functional configuration example of the server device 20 according to the embodiment of the present disclosure has been described. Subsequently, a program retrieval function according to the embodiment of the present disclosure will be described in detail.

<1-5. Program Retrieval Function>

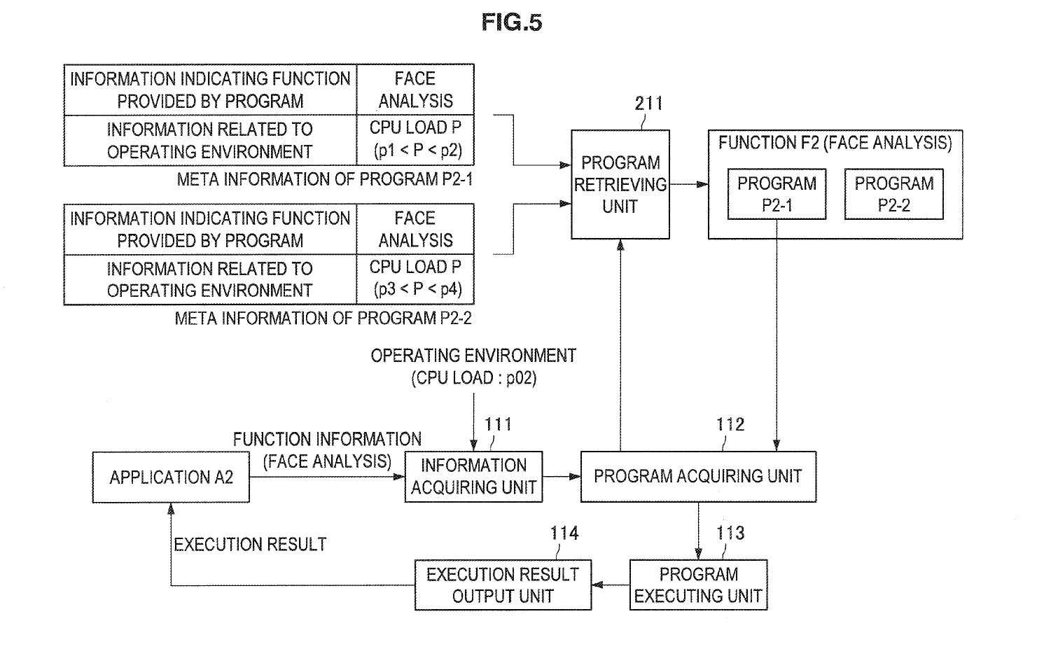

FIG. 5 is a diagram illustrating an example of a program retrieval function. As illustrated in FIG. 5, the information acquiring unit 111 of the information processing device 10 acquires function information, indicating the function required by the application A2, from the application A2. Here, as an example, a case where a function of performing a face analysis on an image, which is included in the information processing device 10, is required by the application A2 will be assumed. Also, the information acquiring unit 111 acquires an operating environment of the application A2. Here, as an example, a case where a load p02 on a CPU included in the information processing device 10 (hereinafter, simply referred to as a “CPU load”) is acquired will be assumed. Here, the CPU load is assumed as being CPU usage, but the CPU may be a CPU use rate.

Subsequently, the program acquiring unit 112 acquires a program corresponding to the operating environment and the function information. The acquisition of the program may be made at any timing. For example, the program acquiring unit 112 may acquire the program in a case where a program acquisition instruction is made by a user operation, or may acquire the program in a case where a program acquisition instruction is made by a notification from the application A2. Also, the program acquiring unit 112 may acquire the program in a case where the application A2 is installed, or may acquire the program when a state of the information processing device 10 is changed.

First, the program acquiring unit 112 notifies the server device 20 of the operating environment and the function information so as to acquire the program. However, in a case where the program has already been acquired, it is only necessary to use the already acquired program. Hence, the program acquiring unit 112 need not notify the server device 20 again of the operating environment and the function information. Also, in a case where the program acquiring unit 112 fails to acquire the program, the already acquired program may be executed in the program executing unit 113.

Subsequently, when the operating environment and the function information are acquired from the program acquiring unit 112, the program retrieving unit 211 of the server device 20 retrieves a program corresponding to the operating environment and the function information. For example, the program retrieving unit 211 selects a program from a program group corresponding to the function information, based on the operating environment and meta information of each program constituting the program group.

In the example illustrated in FIG. 5, the program retrieving unit 211 selects a program from a program group (program P2-1 and program P2-2) of the function F2 corresponding to the face analysis function, based on the operating environment and meta information of each program constituting the program group. The meta information of each program constituting the program group may include information related to the operating environment and information indicating the function provided by the corresponding program.

In FIG. 5, as the meta information, meta information of the program P2-1 and meta information of the program P2-2 are provided. The meta information of the program P2-1 includes information “face analysis” indicating the function provided by the program P2-1 and information “p1<CPU load P<p2” related to the operating environment. Also, the meta information of the program P2-2 includes information “face analysis” indicating the function provided by the program P2-2 and information “p3<CPU load P<p4” related to the operating environment.

The information related to the operating environment, for example, may be preset by a developer or the like, based on an execution state of a test code prepared for each function. For example, in a case where an execution state in which a small CPU load is applied by the execution of the program P2-2 is obtained, the program P2-1 may be set to be used when the CPU load P of the information processing device 10 is larger. Also, in a case where an execution state in which a large CPU load is applied by the execution of the program P2-1 is obtained, the program P2-2 may be set to be used when the CPU load P of the information processing device 10 is smaller.

The computer executing the test code may be the server device 20, or may be a device other than the server device 20. For example, a plurality of devices may be prepared and the test code may be executed in the plurality of devices. The test code may be executed in a developer's computer. Also, the execution result of the test code may be used for purposes other than the meta information generation. For example, the execution result of the test code may be used for security purposes to monitor whether the program accesses unauthorized resources.

The information indicating the function provided by the program, for example, may be preset by a developer or the like. The information indicating the function provided by the program may be selected from one or a plurality of already registered information by a developer or the like. Also, when not yet registered, the information indicating the function provided by the program may be selected from newly added information by a developer or the like.

In the example illustrated in FIG. 5, a case where the CPU load p02 as an example of the operating environment satisfies a condition described in the information “p1<CPU load P<p2” related to the operating environment of the program P2-1 is assumed. In such a case, the program retrieving unit 211 selects the program P2-1 satisfying the corresponding condition. Also, the program providing unit 212 provides the program acquiring unit 112 with the program obtained by the retrieval of the program retrieving unit 211. In the example illustrated in FIG. 5, the program providing unit 212 provides the program acquiring unit 112 with the program P2-1 selected by the program retrieving unit 211.

Also, here, an example in which the program retrieving unit 211 is incorporated in the server device 20 is illustrated, but the program retrieving unit 211 may be provided inside the information processing device 10 in a case where the information processing device 10 can acquire the meta information from the server device 20. Also, an example in which the program providing unit 212 is incorporated in the server device 20 is illustrated, but the program providing unit 212 may be provided outside the server device 20. In such a case, the presence location of the program may be notified from the program retrieving unit 211 to the program acquiring unit 112, and the program acquiring unit 112 may receive the program from the program providing unit 212 provided outside the server device 20.

The program acquiring unit 112 of the information processing device 10 acquires the program provided by the program retrieving unit 211, and the program executing unit 113 executes the program acquired by the program acquiring unit 112. The execution result output unit 114 outputs the execution result of the program, which is obtained by the program executing unit 113, to the application. In the example illustrated in FIG. 5, since a case where the program P2-1 is acquired by the program acquiring unit 112 is assumed, the execution result of the program P2-1 is output to the application A2.

Also, in a case where the program executing unit 113 fails to execute the program, the program acquiring unit 112 may acquire a program separately from the acquired program again according to the operating environment and the function information. For example, in a case where there is a plurality of programs corresponding to the function information, the program acquiring unit 112 may acquire the corresponding different program from the plurality of programs, based on the operating environment.

As described above, in the embodiment of the present disclosure, the program corresponding to the operating environment and the function information is acquired by the information processing device 10. Therefore, it is possible to easily acquire the program for realizing the functions required by the applications, considering the operating environments of the applications. Also, the execution result of the program corresponding to the operating environment and the function information is easily provided to the application.

Also, in the example illustrated in FIG. 5, the CPU load P of the information processing device 10 is used as the operating environment of the application, but the operating environment of the application is not particularly limited as described above. For example, the operating environment of the application may be a communication rate of the information processing device 10. For example, in a case where there are two programs using a face analysis function of an external server, when the communication rate of the information processing device 10 is high, it is necessary to transfer larger data to the external server, but a program capable of obtaining a higher-accuracy analysis result may be acquired from the external server. On the other hand, in a case where the communication rate of the information processing device 10 is low, a lower-accuracy analysis result is obtained from the external server, but a program having only to transfer small data to the external server may be acquired. Also, for example, the operating environment of the application may be a memory space used by the information processing device 10.

Also, for example, the operating environment of the application may be a communication scheme (for example, 3G network, wi-fi, and the like) used for communication by the information processing device 10. For example, in a case where the communication scheme is “3G network”, the congestion of the network 30 is expected to be large, and thus, “communication scheme: 3G network” may be set to the information related to the operating environment of the program in which the processing by the external server is unnecessary. Also, for example, in a case where the communication scheme is “wi-fi”, the congestion of the network 30 is expected to be small, and thus, “communication scheme: wi-fi” may be set to the information related to the operating environment of the program in which the processing by the external server is necessary.

The example of the program retrieval function is not limited to the example illustrated in FIG. 5. Another example of a program retrieval function will be described below. Also, in the following example of the program retrieval function, the description will focus on a difference from the example illustrated in FIG. 5.

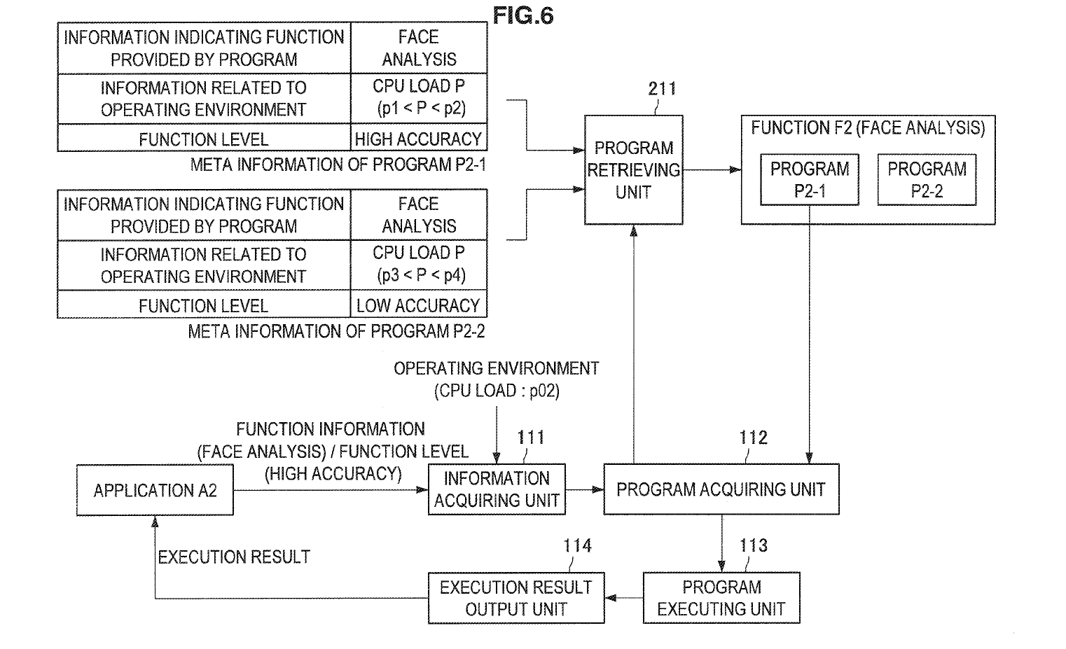

FIG. 6 is a diagram illustrating an example of a program retrieval function. In this example, in addition to the function information, a function level indicating the level of the function is output from the application. As illustrated in FIG. 6, the information acquiring unit 111 may acquire the function level from the application A2, in addition to the function information. In such a case, the program acquiring unit 112 may acquire a program corresponding to the function level.

In the example illustrated in FIG. 6, the function level “high accuracy” is further included in the meta information of the program P2-1. Also, the function level “low accuracy” is further included in the meta information of the program P2-2. In this example, a case where “high accuracy” as an example of the function level output from the application A2 satisfies a condition of information “high accuracy” related to the operating environment of the program P2-1 is assumed. In such a case, the program retrieving unit 211 may select the program P2-1 satisfying the corresponding condition.

Also, FIG. 6 illustrates a case where information indicating whether the function provided by the program is “high accuracy” or “low accuracy” is used as the function level, but the function level is not limited thereto. For example, the function level may be information indicating whether a real-time property is required. For example, a program, the function level of which is “no real-time property”, may be a program that needs more time for processing but gives smaller load to hardware (for example, a CPU, a memory, and the like). Also, a program, the function level of which is “real-time property”, may be a program that gives larger load to hardware (for example, a CPU, a memory, and the like) but needs shorter time for processing. Also, FIG. 6 illustrates a case where the function level is two stages, but the function level may be three or more stages.

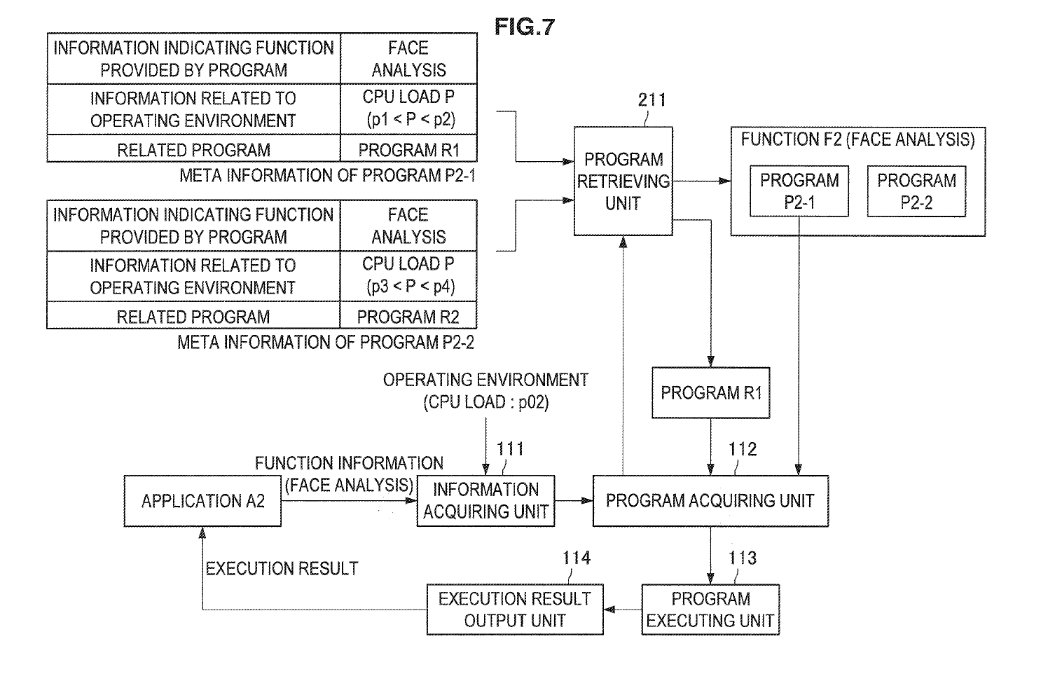

FIG. 7 is a diagram illustrating an example of a program retrieval function. In this example, the program acquiring unit 112 acquires a related program other than a program provided by the program providing unit 212. This is because when the program provided by the program providing unit 212 is executed, it is highly likely that a program having relation to that program will also be executed. The related program is a program having relation to the program provided by the program providing unit 212.

For example, the related program may be a program that is called from the program provided by the program providing unit 212, or may be a program that calls the program provided by the program providing unit 212. Also, for example, in a case where the program provided by the program providing unit 212 and other program are called from the same program, the related program may be the other program. That is, the related program may be a program that is executed by being directly or indirectly combined with the program provided by the program providing unit 212.

In the example illustrated in FIG. 7, the related program “program R1” is further included in the meta information of the program P2-1. Also, the related program “program R2” is further included in the meta information of the program P2-2. In this example, the related program “program R1” of the program P2-1 provided by the program providing unit 212 is further provided to the program acquiring unit 112.

Also, as described below, the meta information of each program is updated by the meta information updating unit 214. Therefore, in a case where there is a plurality of programs that is executed by being combined with the program provided by the program providing unit 212, a program selected from the plurality of programs, based on the execution state, may be included in meta information of the related program. In such a case, a program having stronger relation to the program provided by the program providing unit 212 may be acquired as the related program.

A timing at which the related program is acquired is not particularly limited. For example, the related programs may be sequentially acquired based on an execution stage of a program executed before the corresponding program. By sequentially acquiring the related programs, the capacity of the memory used for storing the programs can be reduced, for example, if the acquisition of the related program is performed while the program executed before the corresponding related program is deleted.

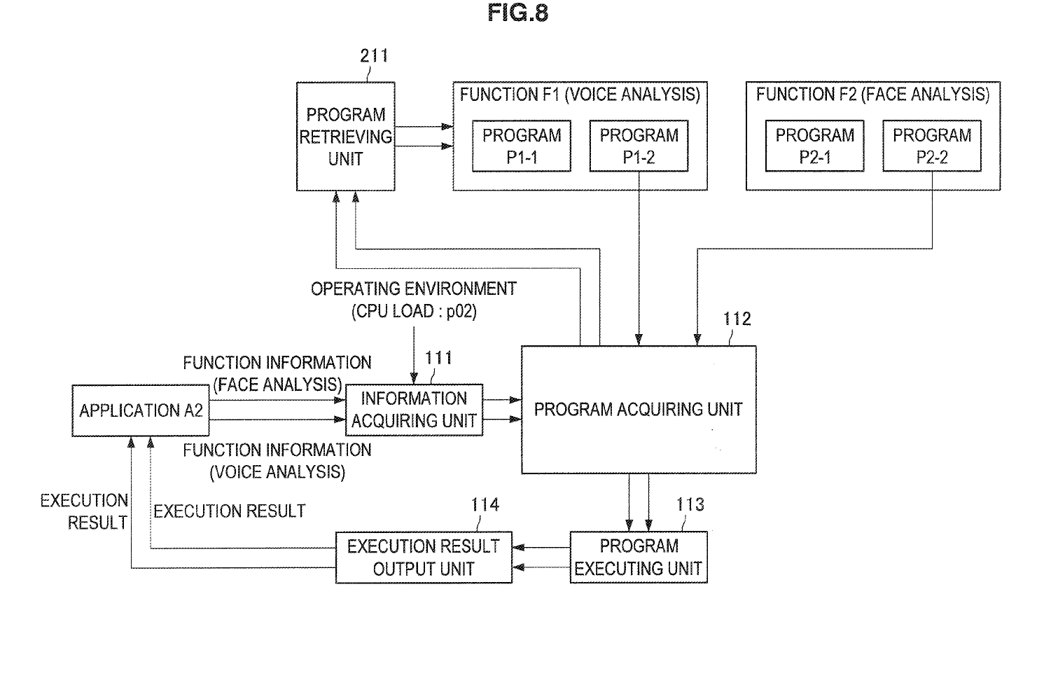

FIG. 8 is a diagram illustrating an example of a program retrieval function. In this example, a case where the information acquiring unit 111 acquires a plurality of function information from the application A2 is assumed. In such a case, the program acquiring unit 112 may acquire each of the corresponding programs, based on priority associated with each of the plurality of function information. The priority may be acquired from the application A2, or the priority may be associated with each function.

In the example illustrated in FIG. 8, function information indicating the function of the face analysis and function information indicating the function of voice analysis are acquired from the application A2 by the information acquiring unit 111. Here, for example, in a case where the priority of the voice analysis function F1 is higher than the priority of the face analysis function F2, the program of the voice analysis function F1 is provided with higher priority than the program of the face analysis function F2.

For example, the program of the voice analysis function F1 may be provided in a manner similar to the case where the priority is not considered. Also, regarding the program of the face analysis function F2, in a case where the priority is not considered, the program P2-1 having a larger processing load is provided, and in a case where the priority is considered, the program P2-2 having a smaller processing load is provided. Considering the case where the program of the voice analysis function F1 is executed, it is desirable to execute the program P2-2 having a smaller processing load.

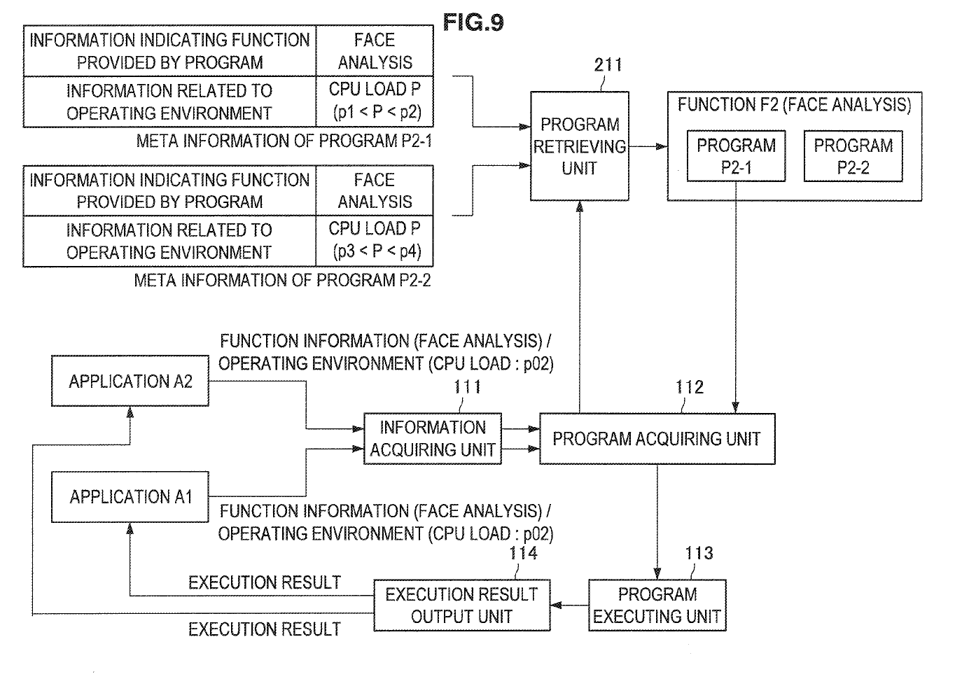

FIG. 9 is a diagram illustrating an example of a program retrieval function. In this example, a case where the information acquiring unit 111 acquires function information from each of a plurality of applications is assumed. In such a case, in a case where the function information acquired from each of the plurality of applications is common, the program acquiring unit 112 may commonalize all or part of the operations of acquiring the respective programs. Such commonalization can reduce the processing load applied to the operation of acquiring the program.

In the example illustrated in FIG. 9, function information indicating the function of the face analysis is acquired from each of the application A1 and the application A2 by the information acquiring unit 111. The operating environments of the respective applications are also common. Therefore, the program acquiring unit 112 has only to commonalize all of the operations of acquiring the program P2-1 corresponding to the face analysis function F2.

The retrieval is performed by the program retrieving unit 211, based on the CPU load p02 as an example of the operating environment and the function information indicating the face analysis function, and when the program P2-1 is acquired, the program P2-1 is provided to the program acquiring unit 112 by the program providing unit 212. In a case where the program P2-1 is acquired by the program acquiring unit 112, the program executing unit 113 executes the program P2-1, and the execution result output unit 114 has only to provide the execution result of the program P2-1 to the application A1 and the application A2.

Also, in a case where the operating environments of the application A1 and the application A2 are different from each other, it is likely that the program corresponding to the function required by the application A1 is different from the program corresponding to the function required by the application A2. In such a case, when both the provided programs are partially common, a part of the acquisition operation can be commonalized.

Also, a case where the function level is acquired from each of the application A1 and the application A2 is assumed. In such a case, in a case where the function information acquired from each of the application A1 and the application A2 is common, the program providing unit 212 may commonalize all or part of the operations of acquiring the respective programs based on the function level acquired from each of the application A1 and the application A2.

For example, in the above-described example, it is considered that the face analysis program P2-1 of which the function level is “high accuracy” and the face analysis program P2-2 of which the function level is “low accuracy” are similar in functions provided by execution. Therefore, it is highly likely that the program P2-1 and the program P2-2 have a common part. Thus, it is considered that the operation of acquiring the common part can be commonalized.

Also, the commonalized program is not limited to the face analysis program. For example, each of the application A1 and the application A2 may be a positioning program. For example, in a case where there are a positioning program P2-1 of which the function level is “high accuracy” and a positioning program P2-2 of which the function level is “low accuracy”, it is highly likely that the program P2-1 and the program P2-2 have a common part. Thus, it is considered that the operation of acquiring the common part can be commonalized.

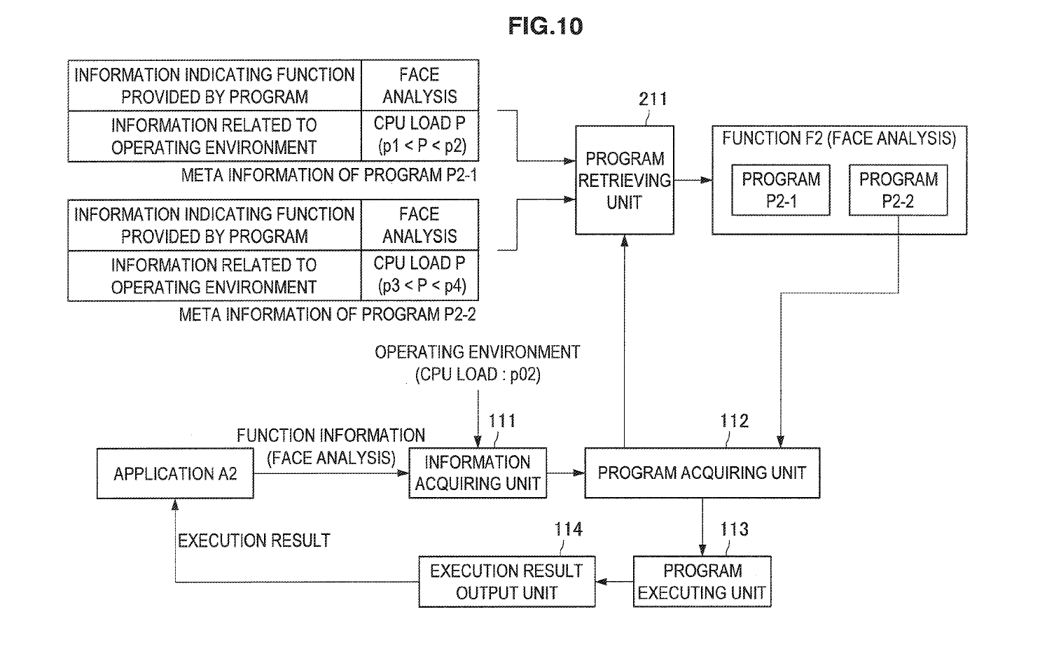

FIG. 10 is a diagram illustrating an example of a program retrieval function. In this example, a case where an operating environment changes is assumed. In such a case, the program acquiring unit 112 may acquire a program separately from the acquired program again according to the changed operating environment and the function information. This is because appropriate program may be changed according to the change in the operating environment of the application. The operating environment may be, for example, the state of the information processing device 10. According to the re-acquisition of the program, the program corresponding to the change in the operating environment of the application can be acquired. Also, information indicating the change in the operating environment may be explicitly given by a user operation.

Also, here, an example in which the program acquiring unit 112 acquires the program again from the server device 20 is illustrated, but the program acquiring unit 112 may previously acquire a plurality of programs associated with priority. In this case, the program acquiring unit 112 may acquire programs with next highest priority from the plurality of already acquired programs according to the change in the operating environment of the application, such that the program executing unit 113 executes the programs in order of higher priority.

In the example illustrated in FIG. 10, a case where the information acquiring unit 111 acquires the CPU load p02 of the information processing device 10 as an example of the operating environment of the application A2 is assumed. Then, a case where the CPU load changes from p02 to p02′ is assumed. In such a case, the program acquiring unit 112 has only to acquire a program corresponding to the changed CPU load p02′ from the program group corresponding to the face analysis function F2. For example, in a case where the program corresponding to the changed CPU load p02′ is changed to the program P2-2, the program providing unit 212 has only to provide the program 2-2 to the program acquiring unit 112.

Also, here, a case where the CPU load changes has been described as an example, but the change in the operating environment is not limited to the change in the CPU load. For example, the change in the operating environment may be a change in a remaining battery level. For example, in a case where the remaining battery level is high, it is desirable to execute a program that has high power consumption but a high processing speed; however, in a case where the remaining battery level is low, it is desirable to execute a program that has a low processing speed but low power consumption.

So far, details of the program retrieval function according to the embodiment of the present disclosure have been described. Subsequently, details of the operation history update function according to the embodiment of the present disclosure will be described.

<1-6. Operation History Update Function>

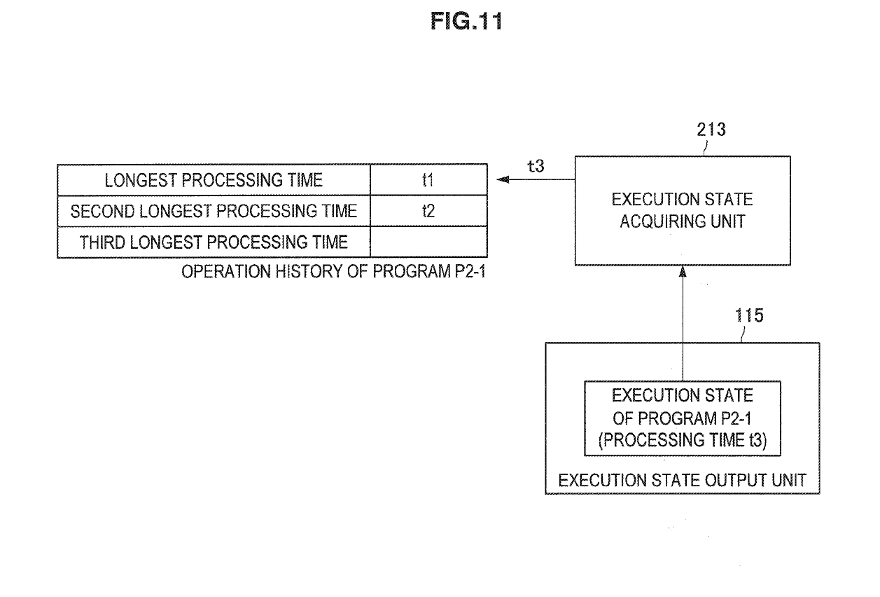

FIG. 11 is a diagram illustrating an example of an operation history update function. As illustrated in FIG. 11, the execution state output unit 115 of the information processing device 10 may output the execution state of the program, which is obtained by the program executing unit 113, to the server device 20. The execution state acquiring unit 213 of the server device 20 may add the execution state to the operation history of the corresponding program. Here, the operation history to which the execution state is added may be used for the update of the meta information, which will be described below. The execution state of the program is not specially limited.

In the example illustrated in FIG. 11, a case where the program P2-1 is executed by the program executing unit 113 is assumed. In such a case, the execution state output unit 115 outputs the execution state of the program P2-1 by the program executing unit 113 to the execution state acquiring unit 213. The execution state of the program P2-1 may be processing time required for the execution of the program P2-1. In the example illustrated in FIG. 11, the processing time t3 is output to the execution state acquiring unit 213.

For example, it is assumed that the longest processing time t1 and the second longest processing time t2 are already recorded in the operation history of the program P2-1. When the processing time t3 is acquired from the execution state output unit 115, the execution state acquiring unit 213 may add the acquired processing time t3 to the operation history of the corresponding program P2-1. Also, as illustrated in FIG. 11, the execution state acquiring unit 213 may register the longest processing time t3, the second longest processing time t1, and the third longest processing time t2 to the operation history of the corresponding program P2-1. Therefore, the execution state acquiring unit 213 may register only more unfavorable execution states to the operation history.

So far, details of the operation history update function according to the embodiment of the present disclosure have been described. Subsequently, details of the meta information update function according to the embodiment of the present disclosure will be described.

<1-7. Meta Information Update Function>

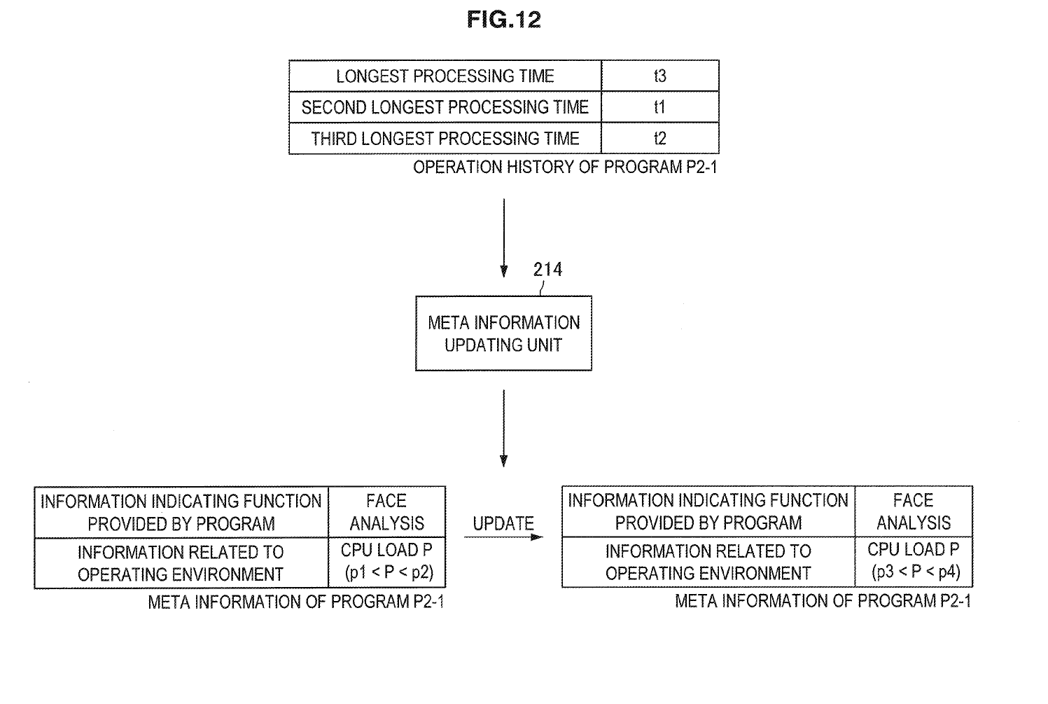

FIG. 12 is a diagram illustrating an example of a meta information update function. As illustrated in FIG. 12, the meta information updating unit 214 of the information processing device 10 may update meta information, based on the operation history of the program. For example, the meta information updating unit 214 may update information related to the operating environment of the program, based on the operation history of the program.

In the example illustrated in FIG. 12, the longest processing time t3 is newly added to the operation history of the program P2-1. For example, when the meta information updating unit 214 compares an average value of processing times registered in the operation history before the addition of the processing time t3 and after the addition of the processing time t3, the average value after the processing time t3 is added becomes greater. Therefore, for example, the meta information updating unit 214 may determine that it is desirable to execute the program P2-1 in a state in which the CPU load is high, and may increase the lower limit of the CPU load from p1 to p1′. A method of determining p1′ is not particularly limited and may be determined based on, for example, an average value.

For example, the above-described example shows that the meta information updating unit 214 updates the CPU load as an example of the information related to the operating environment, based on the processing time of the program, but the information updated by the meta information updating unit 214 is not limited to the CPU load. For example, in a case where the processing time of the program is longer than a predetermined time, the meta information updating unit 214 may add the effect of limiting the provision of the corresponding program to the meta information of the program.

Also, for example, the execution state may be the degree of a cancel operation of a user upon execution of the program (for example, a frequency of the cancel operation, a rate of the cancel operation, and the like). In such a case, for example, the degree of the cancel operation is accumulated as the operation history by the execution state acquiring unit 213. At that time, for example, in a case where the degree of the cancel operation is larger than a predetermined degree, the meta information updating unit 214 considers that the satisfaction of the program is low, and thus, may add the effect of limiting the provision of the corresponding program to the meta information of the program.

Also, in the above-described example, the processing time of the program is output from the information processing device 10 to the server device 20 as the execution state of the program, but the execution state is not limited to such an example. For example, the execution state may be a combination of the processing time and the operating environment. In such a case, for example, the processing time of each operating environment is accumulated as the operation history by the execution state acquiring unit 213. At that time, for example, in a case where there is an operating environment in which the processing time is longer than a predetermined time, the meta information updating unit 214 may add the effect of limiting the provision of the program corresponding to the relevant operating environment to the meta information of the program.

Also, for example, the execution state may be a combination of the degree of error occurrence (for example, a frequency of error occurrence, a rate of error occurrence, and the like) upon execution of the program and the operating environment. In such a case, for example, the degree of the error occurrence for each operating environment is accumulated as the operation history by the execution state acquiring unit 213. At that time, for example, in a case where there is an operating environment in which the degree of the error occurrence is larger than a predetermined degree, the meta information updating unit 214 may add the effect of limiting the provision of the program corresponding to the relevant operating environment to the meta information of the program.

Also, for example, information indicating time zone or location at which the program is executed may be included in the execution state. In such a case, for example, such information is accumulated as the operation history by the execution state acquiring unit 213. At that time, for example, the meta information updating unit 214 may analyze the execution state of the program for each time zone and may analyze the execution state of the program for each location. Also, the meta information updating unit 214 may update meta information for each time zone or each location, based on the analysis result.

Also, for example, information indicating other program executed by being directly or indirectly connected to the corresponding program (for example, program operating at the same time as the corresponding program) may be included in the execution state. In such a case, for example, such information is accumulated as the operation history by the execution state acquiring unit 213. At that time, for example, the meta information updating unit 214 may analyze the execution state of the program for each other program and may analyze the execution state of the program for each other program. Also, the meta information updating unit 214 may update meta information for each other program, based on the analysis result.

Also, here, an example in which the meta information updating unit 214 is incorporated in the server device 20 is illustrated, but the meta information updating unit 214 may be provided in the information processing device 10 in a case where the information processing device 10 can acquire the operation history. Also, the meta information updating unit 214 may be incorporated in a server different from the server device 20.

So far, details of the meta information update function according to the embodiment of the present disclosure have been described. Subsequently, in the following, the flow of the operation of the information processing system 1 according to the embodiment of the present disclosure will be described.

<1-8. Operation Example of Information Processing System>

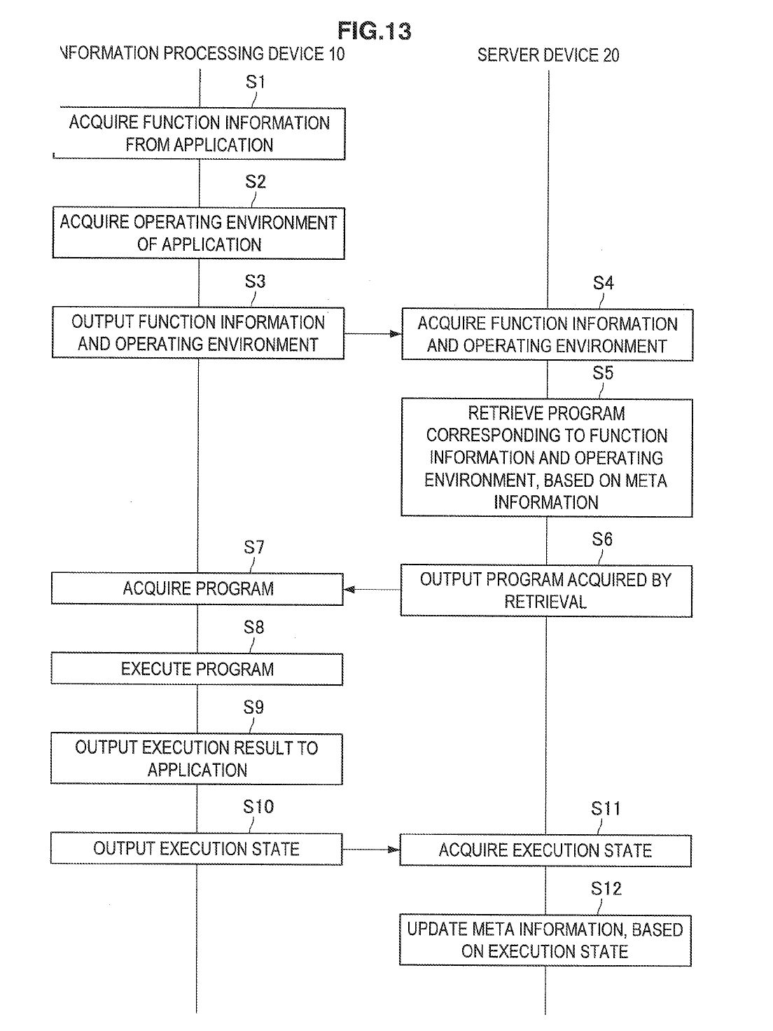

FIG. 13 is a flowchart illustrating the flow of the operation of the information processing system 1 according to the embodiment of the present disclosure. Also, since the operation illustrated in FIG. 13 is merely an example of the operation of the information processing system 1 according to the embodiment of the present disclosure, the flow of the operation of the information processing system 1 according to the embodiment of the present invention is not limited to the flow of the operation illustrated in FIG. 13.

As illustrated in FIG. 13, first, the information acquiring unit 111 acquires function information from the running application (S1). Subsequently, the information acquiring unit 111 acquires an operating environment of the corresponding application (S2). Here, the acquisition order of the function information and the operating environment is not particularly limited. Subsequently, the program acquiring unit 112 outputs the function information and the operation environment, which are acquired by the information acquiring unit 111, to the server device 20 (S3), and the program retrieving unit 211 of the server device 20 acquires the function information and the operation environment (S4).

Subsequently, the program retrieving unit 211 retrieves a program corresponding to the function information and the operating environment, based on meta information (S5), and the program providing unit 212 outputs the program acquired by the retrieval of the program retrieving unit 211 to the information processing device 10 (S6). Subsequently, the program acquiring unit 112 of the information processing device 10 acquires the program from the server device 20 (S7), and the program executing unit 113 executes the program acquired by the program acquiring unit 112 (S8).

Subsequently, the execution result output unit 114 outputs the execution result of the program, which is obtained by the program executing unit 113, to the application (S9), and the execution state output unit 115 outputs the execution state of the program, which is obtained by the program executing unit 113, to the server device 20 (S10). Subsequently, the execution state acquiring unit 213 of the server device 20 acquires the execution state from the information processing device 10 (S11), and the meta information updating unit 214 updates the meta information based on the execution state acquired by the execution state acquiring unit 213 (S12).

So far, the embodiments of the present disclosure have been described.

### 2. Conclusion

As described above, in the embodiment of the present disclosure, there is provided an information processing device including: an information acquiring unit that acquires an operating environment of an application and function information indicating a function required by the application; and a program acquiring unit that acquires a program corresponding to the operating environment and the function information. According to such a configuration, there is provided a technique that can easily acquire programs for realizing functions required by applications, considering operating environments of the applications.

Also, the application can realize the required functions, without being conscious of the operating environment of the application. Furthermore, the application can automatically select and execute the program satisfying the required function level. In a case where the function required by the application is not realized, other program can be acquired and executed, thereby increasing the availability of the application. Furthermore, a program developer can update the program for realizing the function, without updating the application.

The preferred embodiments of the present invention have been described above with reference to the accompanying drawings, whilst the present invention is not limited to the above examples, of course. A person skilled in the art may find various alterations and modifications within the scope of the appended claims, and it should be understood that they will naturally come under the technical scope of the present invention.

For example, the respective steps in the operation of the information processing system 1 of the present specification need not be always processed in time series in order described in the flowchart. For example, the respective steps in the operation of the information processing system 1 may be processed in a different order from that described in the flowchart or in parallel.

Also, hardware embedded in the information processing device 10, such as a CPU, a ROM, and a RAM, can be implemented by a computer program for exhibiting the same functions as the configuration of the above-described information processing device 10. Also, a recording medium having stored therein the computer program is provided.

Similarly, hardware embedded in the server device 20, such as a CPU, a ROM, and a RAM, can be implemented by a computer program for exhibiting the same functions as the configuration of the above-described server device 20. Also, a recording medium having stored therein the computer program is provided.

Additionally, the present technology may also be configured as below.

(1)

An information processing device including:

an information acquiring unit that acquires an operating environment of an application and function information indicating a function required by the application; and

a program acquiring unit that acquires a program corresponding to the operating environment and the function information.

(2)

The information processing device according to (1), further including a program executing unit that executes the program acquired by the program acquiring unit.

(3)

The information processing device according to (2), further including an execution result output unit that outputs an execution result of the program by the program executing unit to the application.

(4)

The information processing device according to any one of (1) to (3),

wherein the program is selected from a program group corresponding to the function information, based on the operating environment and meta information of each program constituting the program group.

(5)

The information processing device according to (4),

wherein the meta information of each program constituting the program group includes information related to the operating environment and information indicating the function provided by the program.

(6)

The information processing device according to (5),

wherein the information related to the operating environment of the program is updated based on an operation history of the program.

(7)

The information processing device according to (6),

wherein the execution state of the program by the program executing unit is added to the operation history of the program and is used to update the meta information of the program, based on the operation history of the program.

(8)

The information processing device according to any one of (4) to (7),

wherein when the program acquiring unit acquires the program, the program acquiring unit acquires a related program, based on the meta information of the program.

(9)

The information processing device according to any one of (1) to (8),

wherein the information acquiring unit acquires a function level, and

wherein the program acquiring unit acquires a program corresponding to the function level.

(10)

The information processing device according to any one of (1) to (9),

wherein when function information acquired from each of a plurality of applications by the information acquiring unit is common, the program acquiring unit commonalizes all or part of the operations of acquiring the respective programs.

(11)

The information processing device according to any one of (1) to (9),

wherein when function information acquired from each of a plurality of applications by the information acquiring unit is common, the program acquiring unit commonalizes all or part of the operations of acquiring the respective programs, based on a function level acquired from each of the plurality of applications by the information acquiring unit.

(12)

The information processing device according to any one of (1) to (11),

wherein when a plurality of pieces of function information is acquired by the information acquiring unit, the program acquiring unit acquires each of the programs, based on priority associated with each of the plurality of function information.

(13)

The information processing device according to (2),

wherein when the program executing unit fails to execute the program, the program acquiring unit acquires a program separately from the program again according to the operating environment and the function information.

(14)

The information processing device according to any one of (1) to (13),

wherein the operating environment includes information indicating a capability of the information processing device to operate the application.

(15)

The information processing device according to any one of (1) to (13),

wherein the operating environment includes information indicating a state of the information processing device to operate the application.

(16)

The information processing device according to (15),

wherein when the state of the information processing device to operate the application is changed, the program acquiring unit acquires a program separately from the program again according to a changed state of the information processing device and the function information.

(17)

An information processing method including:

acquiring an operating environment of an application and function information indicating a function required by the application; and

acquiring a program corresponding to the operating environment and the function information.

(18)

A server device including:

a program retrieving unit that retrieves a program corresponding to an operating environment of an application and function information indicating a function required by the application; and

a program proving unit that provides a program acquired by retrieval of the program retrieving unit.

(19)

A retrieval method including:

retrieving a program corresponding to an operating environment of an application and function information indicating a function required by the application; and

providing a program acquired by retrieval.

(20)

An information processing system including:

an information processing device; and

a server device,

wherein the information processing device includes
an information acquiring unit that acquires an operating environment of an application and function information indicating a function required by the application, and

wherein the server device includes:
a program retrieving unit that retrieves a program corresponding to the operating environment and the function information, and
a program proving unit that provides a program acquired by retrieval performed by the program retrieving unit to the information processing device.

### REFERENCE SIGNS LIST

information processing system information processing device server device network
110 control unit
111 information acquiring unit
112 program acquiring unit
113 program executing unit
114 execution result output unit
115 execution state output unit
120 input unit
130 communication unit
140 storage unit
150 output unit
210 control unit
211 program retrieving unit
212 program providing unit
213 execution state acquiring unit
214 meta information updating unit
230 communication unit
240 storage unit

1. An information processing device comprising:
an information acquiring unit that acquires an operating environment of an application and function information indicating a function required by the application; and
a program acquiring unit that acquires a program corresponding to the operating environment and the function information.

2. The information processing device according to claim 1, further comprising a program executing unit that executes the program acquired by the program acquiring unit.

3. The information processing device according to claim 2, further comprising an execution result output unit that outputs an execution result of the program by the program executing unit to the application.

4. The information processing device according to claim 1,
wherein the program is selected from a program group corresponding to the function information, based on the operating environment and meta information of each program constituting the program group.

5. The information processing device according to claim 4,
wherein the meta information of each program constituting the program group includes information related to the operating environment and information indicating the function provided by the program.

6. The information processing device according to claim 5,
wherein the information related to the operating environment of the program is updated based on an operation history of the program.

7. The information processing device according to claim 6,
wherein the execution state of the program by the program executing unit is added to the operation history of the program and is used to update the meta information of the program, based on the operation history of the program.

8. The information processing device according to claim 4,
wherein when the program acquiring unit acquires the program, the program acquiring unit acquires a related program, based on the meta information of the program.

9. The information processing device according to claim 1,
wherein the information acquiring unit acquires a function level, and
wherein the program acquiring unit acquires a program corresponding to the function level.

10. The information processing device according to claim 1,
wherein when function information acquired from each of a plurality of applications by the information acquiring unit is common, the program acquiring unit commonalizes all or part of the operations of acquiring the respective programs.

11. The information processing device according to claim 1,
wherein when function information acquired from each of a plurality of applications by the information acquiring unit is common, the program acquiring unit commonalizes all or part of the operations of acquiring the respective programs, based on a function level acquired from each of the plurality of applications by the information acquiring unit.

12. The information processing device according to claim 1,
wherein when a plurality of pieces of function information is acquired by the information acquiring unit, the program acquiring unit acquires each of the programs, based on priority associated with each of the plurality of function information.

13. The information processing device according to claim 2,
wherein when the program executing unit fails to execute the program, the program acquiring unit acquires a program separately from the program again according to the operating environment and the function information.

14. The information processing device according to claim 1,
wherein the operating environment includes information indicating a capability of the information processing device to operate the application.

15. The information processing device according to claim 1,
wherein the operating environment includes information indicating a state of the information processing device to operate the application.

16. The information processing device according to claim 15,
wherein when the state of the information processing device to operate the application is changed, the program acquiring unit acquires a program separately from the program again according to a changed state of the information processing device and the function information.

17. An information processing method comprising:
acquiring an operating environment of an application and function information indicating a function required by the application; and
acquiring a program corresponding to the operating environment and the function information.

18. A server device comprising:
a program retrieving unit that retrieves a program corresponding to an operating environment of an application and function information indicating a function required by the application; and
a program proving unit that provides a program acquired by retrieval of the program retrieving unit.

19. A retrieval method comprising:
retrieving a program corresponding to an operating environment of an application and function information indicating a function required by the application; and
providing a program acquired by retrieval.

20. An information processing system comprising:
an information processing device; and
a server device,
wherein the information processing device includes
an information acquiring unit that acquires an operating environment of an application and function information indicating a function required by the application, and
wherein the server device includes:
a program retrieving unit that retrieves a program corresponding to the operating environment and the function information, and
a program proving unit that provides a program acquired by retrieval performed by the program retrieving unit to the information processing device.
